(19) United States
(12) Patent Application Publication
(10) Pub. No.: US 2020/0108978 A1
(43) Pub. Date: Apr. 9, 2020

(54) PET ACCESSORY ORGANIZER AND STORAGE DEVICE

(71) Applicant: Nancy Fordham, Lees Summitt, MO (US)

(72) Inventor: Nancy Fordham, Lees Summitt, MO (US)

(21) Appl. No.: 16/153,948

(22) Filed: Oct. 8, 2018

(51) Int. Cl. B65D 25/04; B65D 33/00; B65D 33/28; A01K 29/00

(52) U.S. Cl. CPC B65D 25/04; A01K 29/00; B65D 33/28; B65D 33/004

(57) ABSTRACT

A pet accessory organizer and storage device to store accessories thereinside, the pet accessory organizer and storage device including a main body including an expandable/collapsible opening disposed at a top portion thereof to open and close to allow the accessories to be inserted through an aperture formed when the expandable/collapsible opening is expanded, at least one draw string to open and close the expandable/collapsible opening, and a sectional pocket insert disposed within the main body, including a center pocket disposed at a center portion of the sectional pocket insert, and a plurality of pockets disposed around the center pocket.

### BACKGROUND

### 1. Field

The present general inventive concept relates generally to a bag, and particularly, to a bag that organizes and stores pet accessories.

### 2. Description of the Related Art

One of the perks of pet companionship is being able to take one's furry friend along on road trips or vacations. However, pets require various pet supplies, toys, and accessories, and having to haul so many items along while managing a pet can be bulky and difficult.

Therefore, there is a need for a travel container that conveniently holds and organizes items and accessories required and/or desired for pets.

### SUMMARY

The present general inventive concept provides a pet accessory organizer and storage device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a pet accessory organizer and storage device to store accessories thereinside, the pet accessory organizer and storage device including a main body including an expandable/collapsible opening disposed at a top portion thereof to open and close to allow the accessories to be inserted through an aperture formed when the expandable/collapsible opening is expanded, at least one draw string to open and close the expandable/collapsible opening, and a sectional pocket insert disposed within the main body, including a center pocket disposed at a center portion of the sectional pocket insert, and a plurality of pockets disposed around the center pocket.

The plurality of pockets may be shaped like pie slices.

The pet accessory organizer and storage device may further include a sectional pocket insert lid to contact a top portion of the sectional pocket insert such that the plurality of pockets and the center pocket are covered.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a pet accessory organizer and storage device, according to an exemplary embodiment of the present general inventive concept; and

FIG. 2 illustrates a top perspective view of the pet accessory organizer and storage device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

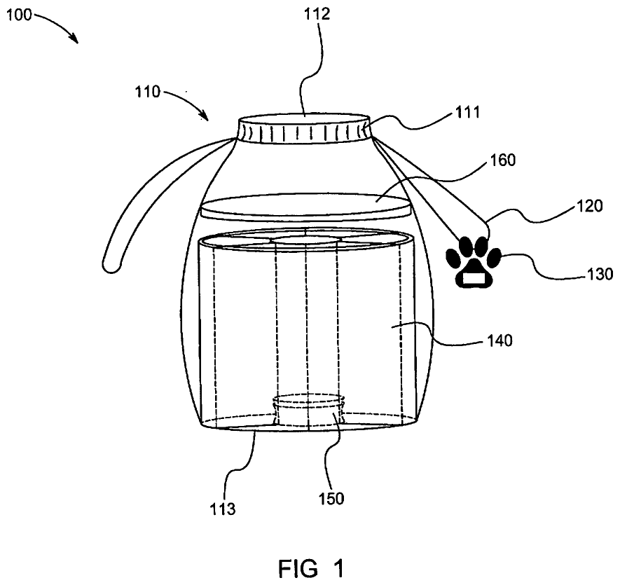

FIG. 1 illustrates a side perspective view of a pet accessory organizer and storage device 100, according to an exemplary embodiment of the present general inventive concept.

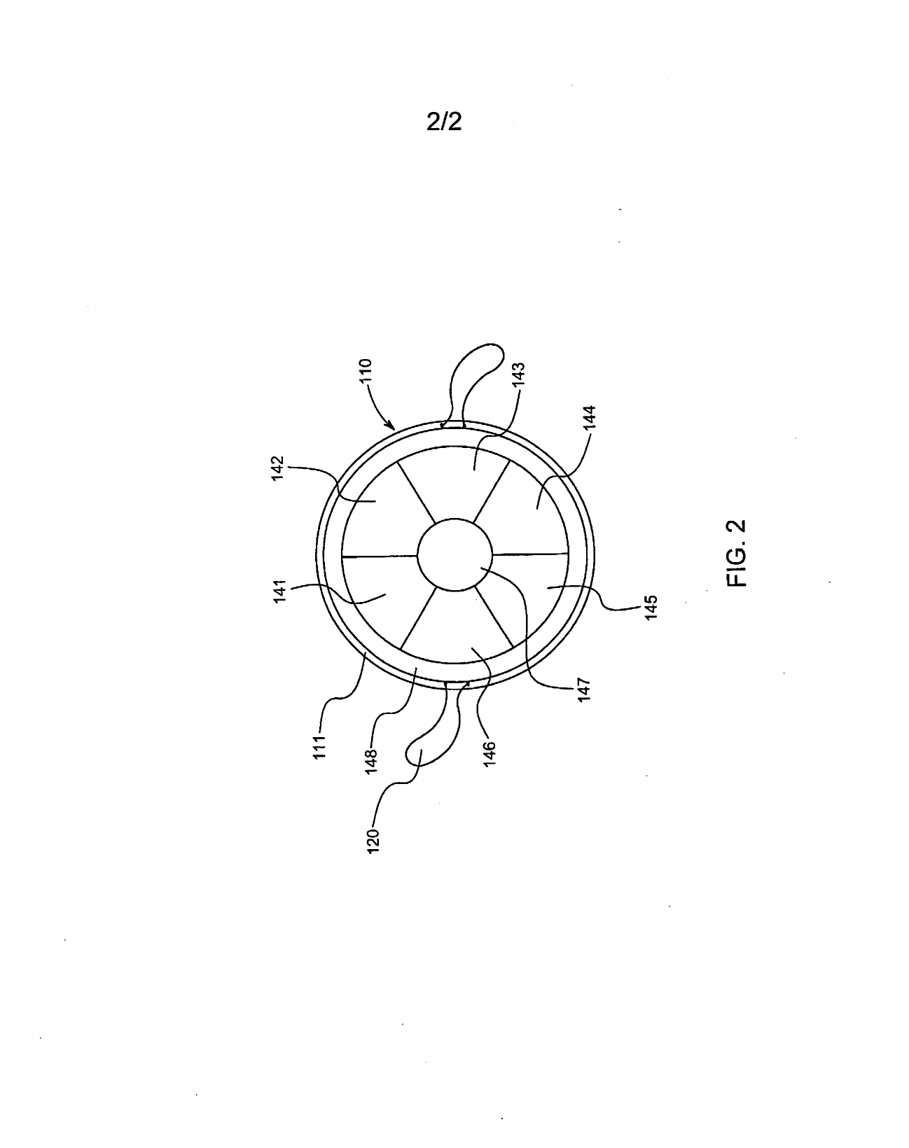

FIG. 2 illustrates a top perspective view of the pet accessory organizer and storage device 100, according to an exemplary embodiment of the present general inventive concept.

The pet accessory organizer and storage device 100 may be designed as a travel-type device, in order to facilitate bringing pet accessories when a user goes on a trip or vacation.

Referring to FIGS. 1 and 2, the pet accessory organizer and storage device 100 may include a main body 110, at least one draw string 120, a name tag 130, a sectional pocket insert 140, at least one bowl 150, and a sectional pocket insert lid 160, but is not limited thereto.

The main body 110 may be constructed from cloth, paper, plastic, rubber, fabric, or any other material known to one of ordinary skill in the art, and may be a bag, a box, or any other type of container known to one of ordinary skill in the art.

The main body 110 may include an expandable/collapsible opening 111 disposed at a top portion of the main body 110, which may be expanded when the at least one draw string 120 is loosened and which may be collapsed (i.e., shut) when the at least one draw string 120 is tightened. In other words, when the at least one draw string 120 is loosened, an aperture 112 through which objects may be placed may increase in size, and when the at least one draw string 120 is tightened, the aperture 112 may decrease in size to the point of closing the aperture 112.

The at least one draw string 120 may be disposed at a side portion of the expandable/collapsible opening 111, and/or, may be connected to the main body 110.

The name tag 130 may be attached to the at least one draw string 120, and may be shaped like an animal paw. Furthermore, the name tag 130 may allow a user to write a name, address, phone number, etc., thereupon, in order to identify an owner's identification information of the pet accessory organizer and storage device 100.

The sectional pocket insert 140 may be disposed within the main body 110, and may be provided to have any height and/or width known to one of ordinary skill in the art.

The sectional pocket insert 140 may have a cylindrical shape, but is not limited thereto, and may have a plurality of pockets 141 through 147. Referring to FIGS. 1 and 2, a plurality of pockets 141 through 146, which may be shaped like pie slices, and a center pocket 147, which may be circular in shape, are illustrated, but the sectional pocket insert 140 may include more or less pockets based on a preference of a user, and may store any items thereinside.

For example, a first pie slice shaped pocket 141 may store animal treats therein. A second pie slice shaped pocket 142 may store a water bottle therein. A third pie slice shaped pocket 143 may store toys therein. A fourth pie slice shaped pocket 144 may store a brush therein. A fifth pie slice shaped pocket 145 may store sanitary wipes therein. A sixth pie slice shaped pocket 146 may store disposable bags therein. However, the plurality of pockets 141 through 146 may store any items therein that a user may desire.

The center pocket 147 may store the food bowl 150 therein, or alternatively, may store a flying disc, ball, or any other object therein.

Again, as illustrated in FIG. 2, the plurality of pockets 141 through 146 may be disposed around the center pocket 147 in a pie-like arrangement.

A top portion of the sectional pocket insert 140 may include an upper surface 148 disposed along an upper circumference thereof.

Referring to FIGS. 1 and 2, the sectional pocket insert lid 160 may be positioned at the top portion of the sectional pocket insert 140, such that the sectional pocket insert lid 160 connects to the upper surface 148. The sectional pocket insert lid 160 may connect to the upper surface 148 via hooks, looks, clasps, buttons, snaps, VELCRO, or any other type of connecting member or fastener known to one of ordinary skill in the art. As such, the sectional pocket insert lid 160 may provide a lid to enclose the plurality of pockets 141 through 147, such that items stored therein may be secured.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A pet accessory organizer and storage device to store accessories thereinside, the pet accessory organizer and storage device comprising:
a main body including an expandable/collapsible opening disposed at a top portion thereof to open and close to allow the accessories to be inserted through an aperture formed when the expandable/collapsible opening is expanded;
at least one draw string to open and close the expandable/collapsible opening; and
a sectional pocket insert disposed within the main body, comprising:
a center pocket disposed at a center portion of the sectional pocket insert, and
a plurality of pockets disposed around the center pocket.

2. The pet accessory organizer and storage device of claim 1, wherein the plurality of pockets are shaped like pie slices.

3. The pet accessory organizer and storage device of claim 1, further comprising:
a sectional pocket insert lid to contact a top portion of the sectional pocket insert such that the plurality of pockets and the center pocket are covered.
